(19) United States
(12) Patent Application Publication
(10) Pub. No.: US 2018/0133727 A1
(43) Pub. Date: May 17, 2018

(54) NOZZLE ARRANGEMENT FOR A SPRAY GUN

(71) Applicant: SATA GmbH & Co. KG, Kornwestheim (DE)

(72) Inventors: EWALD SCHMON, Grafenberg (DE); DANIEL MAIER, Boeblingen (DE)

(73) Assignee: SATA GmbH & Co. KG, Kornwestheim (DE)

(21) Appl. No.: 15/575,549

(22) PCT Filed: May 18, 2016
(86) PCT No.: PCT/EP2016/061057

§ 371 Date: Nov. 20, 2017

(30) Foreign Application Priority Data
May 22, 2015 (DE) 10 2015 006 484.3

(51) Int. Cl. B05B 7/06; B05B 7/08

(52) U.S. Cl. CPC B05B 7/068; B05B 7/0815

(57) ABSTRACT

A nozzle arrangement for a spray gun, in particular a paint spray gun, has at least one paint nozzle and an air cap. The paint nozzle has at least one outlet opening for the material to be sprayed and the air cap has at least one central opening which is bounded by at least one wall. The at least one wall forms a gap with at least one part of the paint nozzle, and a forward part of the paint nozzle has at least an inner face, an outer face and an end face. The end face of the paint nozzle encloses, at least in certain regions, an angle of greater than 90° or an angle of less than 90° with an outer face or an inner face of the paint nozzle. In the nozzle arrangements, the back-pressure counter to the outflow of the material to be sprayed is lower than in prior art nozzles. A spray gun, in particular a paint spray gun, having such a nozzle arrangement is also disclosed.

The invention relates to a nozzle arrangement for a spray gun, in particular a paint spray gun, according to the preamble of claim 1; to a nozzle arrangement for a spray gun, in particular a paint spray gun, according to the preamble of claim 2; to a nozzle arrangement for a spray gun, in particular a paint spray gun, according to the preamble of claim 3; to a nozzle arrangement for a spray gun, in particular a paint spray gun, according to the preamble of claim 4; to a nozzle arrangement for a spray gun, in particular a paint spray gun, according to the preamble of claim 19; and to a spray gun, in particular a paint spray gun, according to the preamble of claim 27.

A nozzle arrangement according to the prior art is disclosed, for example, in the German utility model publication G 94 16 015.5. Said nozzle arrangement is composed substantially of a paint nozzle which by way of an external thread is screw-fitted into a nozzle insert of a paint spray gun. The paint nozzle is surrounded by an air cap which with the aid of an air nozzle ring is screw-fitted to an external thread of the nozzle insert. The external thread of the paint nozzle for screw-fitting into the nozzle insert is adjoined by a central part of a larger diameter, said central part for receiving a paint needle being hollow inside and, on the rear side thereof that faces the external thread has an annular depression. A plurality of identical bores, in the exemplary embodiment shown six identical bores, which are axially parallel and are disposed on a circle about the nozzle longitudinal axis extend from this depression. The nozzle arrangement disclosed in the utility model mentioned furthermore has an air-deflection disk which causes the compressed air flow to be homogenized. Ahead of this air-deflection disk the paint nozzle both on the internal side thereof as well as on the external side thereof has a plurality of faces which in relation to the nozzle longitudinal axis are disposed at dissimilar angles. The front most region of the paint nozzle is formed by a hollow-cylindrical plug which across the profile thereof has a substantially constant internal diameter and a substantially constant external diameter, said plug forming the outlet for the material to be sprayed. The front end face of the plug is substantially perpendicular to the side wall of the plug. It is known in the prior art that the front end of the paint nozzle can be flush with, or lie ahead of or behind the front wall of the air cap about the central opening, or be flush with, or lie ahead of or behind the front end of the central opening. When the spray gun is not in use, the outlet opening is closed from the inside by the paint needle. The paint needle is moved out of the opening only once the trigger is sufficiently activated and releases said opening for the material to be sprayed, the latter then being able to exit the paint nozzle.

An air cap which in the assembled state surrounds the paint nozzle has a central opening, the diameter of the latter being larger than the external diameter of the paint nozzle plug. The central opening of the air cap and the plug of the paint nozzle conjointly form an annular gap. The so-called atomizing air exits from this annular gap, said atomizing air in the nozzle arrangement described above generating a vacuum on the end face, on account of which the material to be sprayed is suctioned from the paint nozzle. The atomizing air meets the paint jet, on account of which the paint jet is shredded to form threads and strings. Said threads and strings, by virtue of the hydrodynamic instability and aerodynamic disturbances thereof, disintegrate so as to form droplets which are blown away from the nozzle by the atomizing air.

The air cap furthermore has two horns which are diametrically opposed and in the outflow direction project beyond the annular gap mentioned and the material outlet opening. Two supply bores run from the rear side of the air cap to exit holes in the horns. Each horn typically has at least one exit hole, but each horn preferably has at least two exit holes. The holes are oriented such that said holes in the exit direction point to the nozzle longitudinal axis behind the annular gap such that the so-called horn air that exits the holes can influence the air that has already exited the annular gap, or the paint jet, or the already at least partially created paint mist, respectively. On account thereof, the originally conical cross section of the paint jet, or of the paint mist, respectively, is compressed on the sides thereof that face the horns and is elongated in the direction that is perpendicular thereto. A so-called wide jet which permits a higher operating rate is created on account thereof. Apart from deforming the paint jet, the horn air has the purpose of further atomizing the paint jet.

So-called control openings can be incorporated in the front face of the air cap, so as to be radially outside the central opening. Said control openings are preferably disposed on a line between the two horns. The air exiting the control openings influences the horn air, in particular weakening the impact of the horn air on the paint jet. The control air furthermore protects the air cap against contamination in that said control air blows paint droplets away from the air cap. Moreover, said control air contributes toward further atomizing of the paint mist and toward transporting the paint mist in the direction of the object to be coated.

Such a nozzle arrangement is above all suitable for use with a spray gun, in particular a paint spray gun, wherein not only paints but also adhesives or lacquers, in particular base and clear lacquers, both solvent-based as well as water-based, but likewise liquids for the food industry, wood-treatment agents, or other liquids may be sprayed. Spray guns can be classified in particular as hand-held spray guns and as automatic or robotic guns, respectively. Hand-held spray guns are used above all by tradesmen, in particular by painters, joiners and varnishers. Automatic and robotic guns are typically used in conjunction with a painting robot or a painting machine for industrial applications. However, it is readily conceivable for a hand-held spray gun also to be integrated in a painting robot or in a painting machine.

The spray gun may have the following in particular: a grip, an upper gun body, a compressed-air connector, a trigger for opening an air valve and for moving the paint needle out of the material outlet opening, a round/wide jet regulator for setting the ratio of atomizing air to horn air in order for the paint jet to be shaped, an air micrometer for setting the spray pressure, a material-amount regulator for setting the maximum volumetric material flow, a material connector, paint ducts for conducting the material to be sprayed from a material inlet to the material outlet, compressed-air ducts, in particular round-jet ducts for supplying the horns with air, and wide-jet ducts for supplying the annular gap and the control openings with air, a suspension hook, and an analog or digital pressure-measuring installation. However, said spray gun can also have other components from the prior art. The paint spray gun can be designed as a flow-cup spray gun, having a paint cup that is disposed above the gun body and from which the material to be sprayed flows substantially by way of gravity into and through the paint ducts. However, the spray gun can also be a side-cup gun in which the paint cup is disposed laterally on the gun body, and in which the material is likewise infed to the gun by gravity. However, the spray gun can also be as a suction-cup gun, having a paint cup that is disposed below the gun body, from which the material to be sprayed is suctioned substantially by negative pressure, in particular while utilizing the Venturi effect, from the cup. Furthermore, said spray gun can be designed as a pressurized-cup gun in which the cup is disposed below, above, or laterally on the gun body and is impinged with pressure, whereupon the medium to be sprayed is squeezed out of the cup. Furthermore, said spray gun can be a bucket gun in which the material to be sprayed is infed to the spray gun from a paint container by means of a hose.

The nozzle arrangement and the spray gun described above have proven successful for many years. However, design embodiments of this type do display shortcomings when spraying materials with a comparatively high viscosity. By virtue of the plug on the paint nozzle the atomizing air exits the annular gap so as to be substantially parallel with the paint jet, which is why the shear forces which are generated on the paint jet that exits the paint nozzle by the atomizing air are insufficient in order for the paint jet, and in particular the material in the center of the jet, to be sufficiently atomized. This results in an excessively coarse paint mist having paint droplets of excessive size, leading to a coating of poor quality.

One solution to this problem would be to increase the air pressure of the atomizing air, which however can lead to an increase in terms of over spraying, that is to say to a lower application efficiency, and to air entrapment and foam formation in the coating.

Therefore, paint nozzles in which the front part has a conical external face without a plug are used for spray pistols according to the prior art. The atomizing air meets the paint jet at an angle of preferably 30° to 45°. High shear forces can be generated herein even at relatively low air pressures of the atomizing air; the atomizing air is able to penetrate the paint jet to a great depth.

However, in the case of such conical nozzles it has proven disadvantageous that the atomizing air that flows along the conical external wall of the paint nozzle does not generate any vacuum on the front end of the paint nozzle, by way of which vacuum the material to be atomized would be suctioned from the paint nozzle, the atomizing air rather generating a positive pressure which counteracts the spray material exiting from the paint nozzle. Therefore, the pressure at which the spray material exits the paint nozzle must be higher than the pressure at which the atomizing air counteracts the paint jet. For this reason, conical nozzles are employed practically exclusively in the case of pressure-fed guns, in particular pressurized-cup guns and bucket guns.

However, the latter have the above-mentioned disadvantages; furthermore the latter are of a more complicated construction and thus more expensive to produce and more complicated to handle than flow-cup, suction-cup, or side-cup guns. Furthermore, said pressure-fed guns have a higher weight which in the case of hand-held spray guns lead to more rapid fatigue of the user and to diminished agility.

It is therefore an object of the present invention to provide a nozzle arrangement for a spray gun, in particular a paint spray gun, and a spray gun, in particular a paint spray gun, by way of which materials with even a comparatively high viscosity can be atomized to a finer degree, but by way of which the material to be sprayed does not have to be supplied to the spray gun under additional pressure.

This object is achieved by a nozzle arrangement, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face, one external face and one end face, characterized in that the end face of the paint nozzle in relation to an external face of the paint nozzle at least in portions encloses an angle of more than 90°.

On account thereof, the atomizing air if at all is not deflected too intensely in the direction of the outlet of the paint nozzle, but is largely directed onward in the spraying direction. The region of the end face which in relation to an external face of the paint nozzle encloses an angle of more than 90° in particular can be a region that is adjacent to the external face of the paint nozzle, wherein the transition can be formed by a chamfer or a radius.

The object is furthermore achieved by a nozzle arrangement, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face, one external face and one end face, characterized in that the end face of the paint nozzle in relation to an external face of the paint nozzle at least in portions encloses an angle of less than 90°.

On account thereof, the outlet of the paint nozzle is at least in part shielded by the atomizing air, which is why the atomizing air if at all generates a lower pressure counter to the outflow of the paint jet. Here too, the region of the end face which in relation to an external face of the paint nozzle encloses an angle of more than 90° in particular can be a region that is adjacent to the external face of the paint nozzle, wherein the transition can be formed by a chamfer or a radius.

This object is likewise achieved by a nozzle arrangement for a spray gun, in particular a paint spray gun, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face, one external face and one end face, characterized in that the end face of the paint nozzle in relation to an internal face of the paint nozzle at least in portions encloses an angle of more than 90°.

The outlet of the paint nozzle is thus also at least in part shielded by the atomizing air. The explanations above apply hereto in an analogous manner.

The object is moreover achieved by a nozzle arrangement for a spray gun, in particular a paint spray gun, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face, one external face and one end face, characterized in that the end face of the paint nozzle in relation to an internal face of the paint nozzle at least in portions encloses an angle of less than 90°.

As is the case in the above-mentioned nozzle arrangement, the atomizing air here if at all is aslo not deflected so intensely in the direction of the outlet of the paint nozzle but rather is largely directed onward in the spraying direction. The explanations above apply hereto in an analogous manner.

The object is furthermore achieved by a nozzle arrangement which has at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap, characterized in that the paint nozzle at the front end thereof has a substantially hollow-cylindrical plug, and wherein the air cap has an internal face which is adjacent to the wall that delimits the central opening of the air cap and which is disposed on that side of the wall that faces away from the spraying direction, characterized in that an imaginary straight line which runs parallel with the internal face of the air cap and intersects the paint nozzle longitudinal axis does not intersect the hollow-cylindrical plug.

The imaginary straight line can run parallel with both the internal face of the air cap as well as the external face of the paint nozzle, should these two faces be mutually parallel. On account of the design embodiment mentioned, part of the atomizing air can act directly on the paint jet without being deflected by the plug. Other parts of the air flow are deflected by the plug and on the end face of the latter create a vacuum for suctioning the material to be sprayed out of the outlet opening of the paint nozzle, or flow in the spraying direction and transport the paint jet, or the paint mist, respectively, in the direction of the object to be coated.

Advantageous design embodiments are the subject matter of the dependent claims.

The “front part of the paint nozzle” is at all times to be understood to be that part of the paint nozzle that faces the spraying direction.

The external face of the paint nozzle in a front region can be disposed so as to be substantially parallel with the internal face of the paint nozzle, that is to say that the paint nozzle in this region has a constant wall thickness. The front region herein can be designed so as to be hollow-cylindrical in the form of a plug, or be designed so as to be conical. The external face of the paint nozzle in a front region in relation to the internal face of the paint nozzle can however also be disposed at an angle of more than 0° and less than 90°. The external face herein can be designed so as to be cylindrical, and the internal face can be designed so as to be conical, such that the interior of the paint nozzle tapers or widens in the spraying direction. However, the internal face of the paint nozzle can also be cylindrical, and the external diameter of the paint nozzle can become larger or smaller in the spraying direction. In the case of the latter, the internal face of the paint nozzle in a front region advantageously runs so as to be substantially parallel with the paint nozzle longitudinal axis. The interior of the paint nozzle can however in a front region also taper or widen in the spraying direction.

The end face of the paint nozzle in relation to an internal face of the paint nozzle at least in regions can enclose an angle of more than 90° or less than 90°. The above-mentioned effects, specifically shielding the material outlet of the paint nozzle, or directing the atomizing air in the spraying direction, respectively, can also be achieved on account thereof. Furthermore, the region of the end face which in relation to an internal face of the paint nozzle encloses an angle of less than or more than 90° can also herein be in particular a region which is adjacent to the internal face of the paint nozzle, wherein the transition can be formed by a chamfer or by a radius.

The end face of the paint nozzle can be assembled from at least two faces which in relation to the external face of the paint nozzle enclose dissimilar angles. The end face at least in part can also be designed so as to be concave, convex, or S-shaped. The same applies to the internal and the external face of the paint nozzle. Guiding of the atomizing air jet and of the paint jet is possible in a homogenous and targeted manner on account thereof.

The wall that delimits the central opening of the air cap is advantageously disposed so as to be at least in part substantially parallel with the external face of the paint nozzle. However, said wall in a region that faces away from the spraying direction can also have a spacing from the external face of the paint nozzle that is larger or smaller than in a region that faces the spraying direction. The wall can also be designed so as to be convex or concave at least in regions.

The paint nozzle advantageously has at least one duct for conducting air. This air by the ducts mentioned is directed from the air ducts in the gun body, or from the air distribution ring, respectively, to the air cap.

The nozzle arrangement according to the invention preferably has an air-deflection disk for homogenizing the pressure conditions, said air-deflection disk preferably being disposed ahead of the just-mentioned ducts in the paint nozzle. The air that flows from the ducts is deflected and homogenized on account thereof.

The air cap preferably has at least two horns each having at least one horn air opening, wherein the horns are diametrically opposed and in the spraying direction project beyond the annular gap mentioned and the material outlet opening. The horn air openings can have dissimilar diameters, shapes, and alignments in relation to the horns and to the paint nozzle longitudinal axis, and can be designed as inserts. All openings can be of identical design; however the openings that in each case are diametrically opposed are advantageously of identical design but in terms of, for example, the diameter thereof and the alignment thereof are dissimilar to the other openings that are in each case diametrically opposed.

The air cap in at least one region between the central opening and the horns can have control ducts for exhausting air. The control ducts direct the air from the interior of the air cap to the outside. Said control ducts can be in a straight line between the two horns, but can also be disposed beside this line. The control ducts herein in the assembled state of the paint nozzle and the air cap can be at least in regions disposed so as to be substantially parallel with the paint nozzle longitudinal axis.

However, said control ducts can also completely or in regions face the paint nozzle longitudinal axis or face away from the latter. This applies in particular to the outlet end of the control ducts. If the outlet ends face the paint nozzle longitudinal axis, the air flowing out of the control ducts can be conjointly used for atomizing. If the control ducts face away from the paint nozzle longitudinal axis and are aligned toward the horn air flow, said control ducts can be used for weakening the horn air, on account of which the risk of the paint jet being split by the horn air is reduced. The control ducts can have arbitrary shapes and sizes, and can be disposed at any angle in relation to the paint nozzle longitudinal axis. Said control ducts can also be designed as inserts. All control ducts can be of identical design, but can also be at least in part designed so as to be dissimilar. The control ducts can in each case also be assembled from a plurality of ducts. For example, two bores which can also be mutually oblique can form one control duct. One of the bores, in particular a blind bore, herein can be incorporated in the air cap from the rear side of the latter, and another bore can be incorporated from the front side, for example. Both bores meet in the interior of the air cap wall.

Furthermore, the nozzle arrangement according to the invention can of course also have other components or design embodiments according to the prior art.

The spray gun, in particular the paint spray gun, according to the invention is characterized in that said spray gun has a nozzle arrangement as claimed in one of the preceding claims.

The spray gun can advantageously have a hollow needle which can be designed for conducting material for spraying or compressed air. For example, a higher throughput of material, or spraying of bi-component material, is possible by way of a hollow needle that conducts material for spraying. To this end, the hollow needle is connected directly or indirectly to a supply of material. If and when the hollow needle is designed so as to conduct compressed air, said needle by way of expelling atomizing air may contribute toward atomizing the material for spraying. To this end, the hollow needle is connected directly or indirectly to a supply of compressed air. In all cases, the hollow needle can be designed for conducting an arbitrary volumetric flow. A person skilled in the art will be familiar with the fact that the throughput depends on the internal diameter of the hollow needle and on the input pressure and the volumetric flow.

Furthermore, the spray gun according to the invention can of course also have other components or design embodiments according to the prior art, for example a round jet/wide jet regulator by means of which arbitrary ratios in terms of the atomizing and horn air pressure and arbitrary ratios in terms of the atomizing and horn air volumetric flow can be adjusted. A pressurized cup which by virtue of the nozzle arrangement according to the invention can be impinged by way of a lower pressure than in the case of nozzle arrangements according to the prior art can also be applied in order for the atomizing output to be increased.

The invention will be explained in more detail hereunder in an exemplary manner by means of eleven drawings in which:

FIG. 1 shows a nozzle arrangement according to the prior art, in a partial sectional view;

FIG. 2 shows a detail of a first exemplary embodiment of a nozzle arrangement according to the invention, in a sectional view;

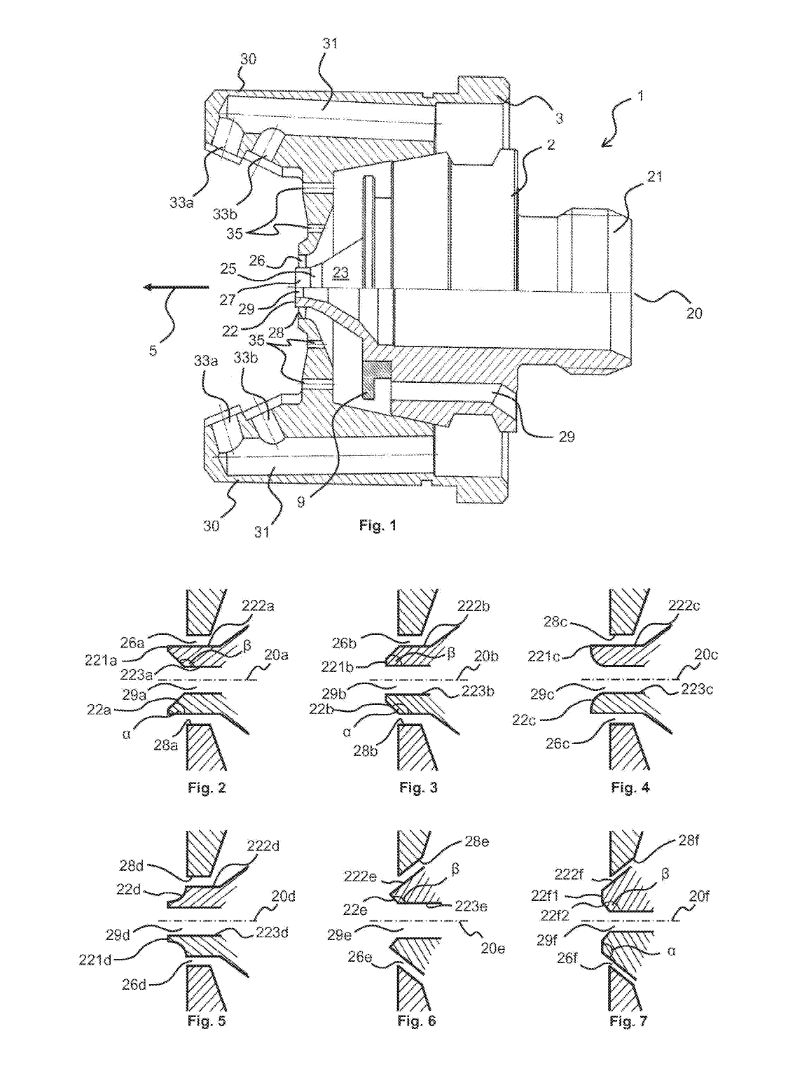

FIG. 3 shows a detail of a second exemplary embodiment of a nozzle arrangement according to the invention, in a sectional view;

FIG. 4 shows a detail of a third exemplary embodiment of a nozzle arrangement according to the invention, in a sectional view;

FIG. 5 shows a detail of a fourth exemplary embodiment of a nozzle arrangement according to the invention, in a sectional view;

FIG. 6 shows a detail of a fifth exemplary embodiment of a nozzle arrangement according to the invention, in a sectional view;

FIG. 7 shows a detail of a sixth exemplary embodiment of a nozzle arrangement according to the invention, in a sectional view;

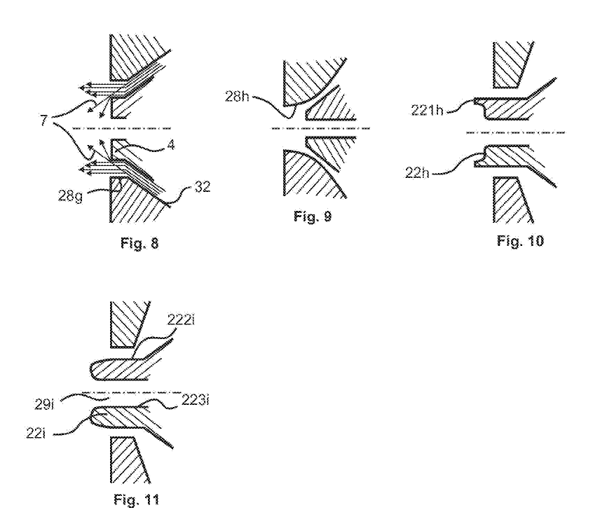

FIG. 8 shows a detail of a seventh exemplary embodiment of a nozzle arrangement according to the invention, in a sectional view;

FIG. 9 shows a detail of an eighth exemplary embodiment of a nozzle arrangement according to the invention, in a sectional view;

FIG. 10 shows a detail of a ninth exemplary embodiment of a nozzle arrangement according to the invention, in a sectional view; and

FIG. 11 shows a detail of a tenth exemplary embodiment of a nozzle arrangement according to the invention, in a sectional view.

FIG. 1 shows a nozzle arrangement 1 according to the prior art, having a paint nozzle 2 and an air cap 3. The paint nozzle 2 by way of an external thread 21 is screw-fitted into a nozzle insert of a paint spray gun (not shown in FIG. 1). The air cap 3 with the aid of an air nozzle ring (not shown in FIG. 1) is screw-fitted to an external thread of the nozzle insert. The external thread 21 of the paint nozzle 2 for screw-fitting the nozzle insert is adjoined by a central part having a larger diameter, said central part for receiving a paint needle (not shown in FIG. 1) being hollow inside and on the rear side thereof that faces the external thread having an annular depression. A plurality of identical bores 29, in the exemplary embodiment shown six identical bores 29, which are axially parallel and are disposed on a circle about the nozzle longitudinal axis extend from this depression. The nozzle arrangement 1 disclosed in FIG. 1 furthermore has an air deflection disk 9 which causes the compressed air flow to be homogenized. Ahead of this air-deflection disk 9 the paint nozzle 2 both on the internal side thereof as well as on the external side thereof has a plurality of faces which in relation to the nozzle longitudinal axis are disposed at dissimilar angles. The front most region of the paint nozzle is formed by a hollow-cylindrical plug 27 which across the profile thereof has a substantially constant internal diameter and a substantially constant external diameter, said plug 27 forming the outlet 29 for the material to be sprayed. The front end face 22 of the plug 27 is substantially perpendicular to the side wall of the plug. When the spray gun is not in use, the outlet opening 29 is closed from the inside by a paint needle. The paint needle is moved out of the opening only once the trigger is sufficiently activated and releases said opening for the material to be sprayed, the latter then being able to exit the paint nozzle 2 or the outlet opening 29 of the latter, respectively.

An air cap 3 which in the assembled state surrounds the paint nozzle 2 has a central opening, the diameter of the latter being larger than the external diameter of the paint nozzle plug. It is known in the prior art that the front end of the paint nozzle 2 can be flush with, or lie ahead of or behind the front wall of the air cap 3 about the central opening, or be flush with, or lie ahead of or behind the front end of the central opening, respectively. The central opening of the air cap 3 and the plug of the paint nozzle 2 conjointly form an annular gap 26. The so-called atomizing air exits from this annular gap 26, said atomizing air in the nozzle arrangement described above generating a vacuum on the end face 22 of the paint nozzle 2, on account of which the material to be sprayed is suctioned from the paint nozzle 2. The atomizing air meets the paint jet, on account of which the paint jet is shredded to form threads and strings. Said threads and strings, by virtue of the hydrodynamic instability and aerodynamic disturbances thereof, disintegrate so as to form droplets which are blown away from the nozzle by the atomizing air.

The air cap 3 furthermore has two horns 30 which are diametrically opposed and in the spraying direction 5 project beyond the annular gap 26 mentioned and the material outlet opening 29. Two supply bores 31 run from the rear side of the air cap 3 to exit holes 33a, 33b in the horns 30. Each horn typically has at least one exit hole, but each horn preferably has at least two exit holes. The holes 33a, 33b are oriented such that said holes 33a, 33b in the exit direction 5 point to the nozzle longitudinal axis 20 behind the annular gap 26 such that the so-called horn air that exits the holes 33a, 33b can influence the air that has already exited the annular gap 26, or the paint jet, or the already at least partially created paint mist, respectively. On account thereof, the originally conical cross section of the paint jet, or of the paint mist, respectively, is compressed on the sides thereof that face the horns 30 and is elongated in the direction that is perpendicular thereto. A so-called wide jet which permits a higher operating rate is created on account thereof. Apart from deforming the paint jet, the horn air has the purpose of further atomizing the paint jet.

So-called control openings 35 can be incorporated in the front face of the air cap 3, so as to be radially outside the central opening. Said control openings 35 are preferably disposed on a line between the two horns 30. The air exiting the control openings 35 influences the horn air, in particular weakening the impact of the horn air on the paint jet. The control air furthermore protects the air cap 3 against contamination in that said control air blows paint droplets away from the air cap 3. Moreover, said control air contributes toward further atomizing of the paint mist and toward transporting the paint mist in the direction of the object to be coated.

The invention will be explained in more detail by means of a plurality of exemplary embodiments in the drawings hereunder. Those parts of the nozzles which in the figures are shown in a sectional view are designed in a rotationally symmetrical manner. The lower part of the drawing therefore mirrors the upper part along the longitudinal axis. For reasons of space, the reference signs have therefore only been entered on one side of the longitudinal axis.

Alternatively, the nozzles can also be designed so as to be elongate or square.

The spraying direction that in FIG. 1 is identified by the reference sign 5 also applies to drawings 2 to 11.

FIG. 2 shows a first exemplary embodiment of a nozzle arrangement according to the invention, wherein only the relevant fragment of the nozzle arrangement is illustrated. The internal face 223a of the paint nozzle in the present exemplary embodiment is substantially parallel with the external face 222a of the paint nozzle. The end face 22a in relation to the external face 222a of the paint nozzle encloses an angle a of less than 90°. At the same time, the end face 22a in relation to the internal face 223a of the paint nozzle encloses an angle β of more than 90°. The wall 28a that delimits the central opening of the air cap is substantially parallel with the external face 222a, the internal face 223a, and the longitudinal axis 20a of the paint nozzle. The wall 28a that delimits the central opening of the air cap, conjointly with the external face 222a of the paint nozzle, forms a gap 26a. The end face 22a in the present case is composed of only one face which is adjacent to the external face 222a of the paint nozzle. There is only a chamfer 221a between the two faces. Said chamfer 221a is advantageous since a sharp-edged nozzle tip can lead to injuries and is more prone to damage than a nozzle tip having a chamfer or a radius. In principle, all edges can be slightly beveled or rounded. All chamfers illustrated in the figures can also represent larger faces. The present design embodiment of the nozzle arrangement has the advantage that the outlet opening 29a of the paint nozzle is shielded by the air exiting from the gap 26a.

FIG. 3 shows an exemplary embodiment of the nozzle arrangement according to the invention, in which the angle a between the external face 222b and the end face 22b of the paint nozzle is more than 90°, the angle β between the internal face 223b and the end face 22b being less than 90°. A chamfer 221b forms the front end of the paint nozzle. However, a further chamfer or radius can also be provided between the external face 222b and the end face 22b of the paint nozzle. The wall 28b that delimits the central opening of the air cap, the external face 222b of the paint nozzle, and the internal face 223b of the paint nozzle here too are substantially parallel with the paint nozzle longitudinal axis 20b. Here too, the wall 28b that delimits the central opening of the air cap, conjointly with the external face 222b of the paint nozzle, forms a gap 26b. It is advantageous in this second exemplary embodiment that the atomizing air, immediately upon exiting the gap 26b, cannot expand in the direction of the outlet 29b of the paint nozzle, as would be the case with a paint nozzle having an end face that is perpendicular to the external wall, but that the atomizing air from the end face 22b is guided onward in the spraying direction. The air flow, also on account of the Coand\check{a} effect, follows the transition from the external face 222b to the end face 22b. The air meets the paint jet and atomizes the latter. The chamfer 221b can also be designed as a larger face on which the atomizing air can generate a vacuum on account of which the material to be sprayed is suctioned from the outlet opening 29b.

An exemplary embodiment of the nozzle arrangement according to the invention having an end face 22c in a convex design is shown in FIG. 4, wherein the angle between the end face 22c and the external face 222c of the paint nozzle is less than 90°. In the case of curved end faces, the angle between the end face and the external face of the paint nozzle is defined as the angle between the tangent to the end face and the external face of the paint nozzle, or as the angle between a straight line from the starting point to the ending point of the curvature and the external face of the paint nozzle. The wall 28c that delimits the central opening of the air cap, the external face 222c of the paint nozzle, and the internal face 223c of the paint nozzle, here too, are substantially parallel with the paint nozzle longitudinal axis 20c. Here too, the wall 28c that delimits the central opening of the air cap, conjointly with the external face 222c of the paint nozzle, forms a gap 26c. It is advantageous in this embodiment that the paint jet that exits the outlet opening 29c can spread uniformly along the end face 22c. The chamfer 221c can also be designed as a larger face on which the atomizing air can generate a vacuum by way of which the material to be sprayed is suctioned from the outlet opening 29c.

FIG. 5 shows a type of spoiler nozzle, the end face of the latter being formed by a concave face 22d and by a straight face or a chamfer 221d. The air that flows from the gap 26d, on account of the Coand\check{a} effect, follows the curvature and is directed in the spraying direction. The front, thin part of the paint nozzle can also be designed so as to be shorter such that the atomizing air on account of the curvature is directed more intensely in the direction of the paint nozzle longitudinal axis 20d, on account of which said atomizing air can act more intensely on the paint jet. If the chamfer 221d is designed as a larger face, the atomizing air thereon can generate a vacuum by way of which the material to be sprayed is suctioned from the outlet opening 29d.

The nozzle arrangements illustrated in FIGS. 2 to 5 indeed all show a paint nozzle having a plug, that is a front part having an internal face and an external face running parallel with the paint nozzle longitudinal axis; however, the design embodiments mentioned above can also be applied to conical nozzles.

A paint nozzle having a conical external face 222e is shown in FIG. 6. The wall 28e that delimits the central opening of the air cap here is substantially parallel with the external face 222e. The end face 22e here is approximately perpendicular to the external face 222e, the angle 13 between the internal face 223e and the end face 22e being more than 90°. However, in particular the angle between the end face 22e and the external face 222e can be more than or less than 90°. Of course, transitions between faces herein can also be formed by a chamfer or a radius.

The nozzle arrangement shown in FIG. 7 likewise has a paint nozzle having a conical external face 222f. The end face here is composed of two faces 22f1, 22f2, which are disposed at dissimilar angles in relation to the paint nozzle longitudinal axis. Both the angle a between the internal face and the end face, as well as the angle β between the external face and the end face, are more than 90°. The end face in relation to the internal face and in relation to the external face of the paint nozzle thus at least in regions encloses an angle of more than 90°.

FIG. 8 shows a nozzle arrangement according to the invention, having a wall 28g that delimits the central opening, a substantially hollow-cylindrical plug 4, and an internal face 32 that is adjacent to the wall 28g. An imaginary straight line 7 which runs so as to be parallel with the internal face 32 of the air cap and intersects the paint nozzle longitudinal axis does not intersect the hollow-cylindrical plug. The imaginary straight line in FIG. 8 is parallel with both the internal face of the air cap as well as with the external face of the paint nozzle. On account of the design embodiment shown, part of the atomizing air (symbolized by the arrows) can act directly on the paint jet without being deflected by the plug. This part of the atomizing air runs in a manner approximately identical to that of the straight line 7. Other parts of the air flow are deflected by the plug and on the end face of the latter generate a vacuum for suctioning the material to be sprayed from the outlet opening of the paint nozzle, or flow in the spraying direction and transport the paint jet or the paint mist, respectively, in the direction of the object to be coated.

A nozzle arrangement having an air cap wall 28h in a convex design is illustrated in FIG. 9.

The nozzle arrangement shown in FIG. 10 has a paint nozzle having a substantially S-shaped end face 22h and chamfer or face 221h.

FIG. 11 shows a paint nozzle having a rounded end face 22i, wherein the rounding here on the external face 222i in the spraying direction commences ahead of the rounding on the internal face 223i. The end face 223i in relation to the external face 222i thus encloses an angle of more than 90°, the end face 223i in relation to the internal face 223i enclosing an angle of less than 90°.

In the case of all exemplary embodiments mentioned, the pressure counter to the outflow of the material to be sprayed is lower than in the case of nozzle according to the prior art.

The drawings illustrated are to be understood as merely not-to-scale diagrams, and the exemplary embodiments are to be understood as merely exemplary. The thickness of the paint nozzle walls and the thickness of the wall that delimits the central opening of the air cap can vary, as can the projections of the paint nozzle beyond the front end of the air cap, the internal diameter and the external diameter of the paint nozzle, the size of the chamfers and radii, and the spacings between the paint nozzle and the air cap, in particular the spacings between the paint nozzle and the wall that delimits the central opening of the air cap. All design embodiments of end faces shown can be employed in the case of both paint nozzles with plugs, as well as paint nozzles without plugs, that is to say in which at least a front region is designed so as to be conical.

1. A nozzle arrangement for a spray gun, in particular a paint spray gun, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face one external face and one end face, wherein the end face of the paint nozzle in relation to an external face of the paint nozzle at least in portions encloses an angle of more than 90°.

2. A nozzle arrangement for a spray gun, in particular a paint spray gun, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face one external face and one end face, wherein the end face of the paint nozzle in relation to an external face of the paint nozzle at least in portions encloses an angle of less than 90°.

3. A nozzle arrangement for a spray gun, in particular a paint spray gun, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face one external face and one end face, wherein the end face of the paint nozzle in relation to an internal face of the paint nozzle at least in portions encloses an angle of more than 90°.

4. A nozzle arrangement for a spray gun, in particular a paint spray gun, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap and wherein a front part of the paint nozzle has at least one internal face, one external face and one end face, characterized in that wherein the end face of the paint nozzle in relation to an internal face of the paint nozzle at least in portions encloses an angle of less than 90°.

5. The nozzle arrangement as claimed in claim 1, wherein the external face of the paint nozzle in a front region is disposed so as to be substantially parallel with the internal face of the paint nozzle.

6. The nozzle arrangement as claimed in claim 1, wherein the external face of the paint nozzle in a front region in relation to the internal face of the paint nozzle is disposed at an angle of more than 0° and less than 90°.

7. The nozzle arrangement as claimed in claim 1, wherein the internal face of the paint nozzle in a front region runs so as to be substantially parallel with the paint nozzle longitudinal axis.

8. The nozzle arrangement as claimed in claim 1, wherein the interior of the paint nozzle in a front region tapers in the spraying direction.

9. The nozzle arrangement as claimed in claim 1, wherein the interior of the paint nozzle in a front region widens in the spraying direction.

10. The nozzle arrangement as claimed in claim 1, wherein the end face of the paint nozzle is assembled from at least two faces which in relation to the internal face of the paint nozzle enclose dissimilar angles.

11. The nozzle arrangement as claimed in claim 1, wherein the end face at least in part is designed so as to be concave.

12. The nozzle arrangement as claimed in claim 1, wherein the end face at least in part is designed so as to be convex.

13. The nozzle arrangement as claimed in claim 1, wherein the end face at least in part is designed so as to be S-shaped.

14. The nozzle arrangement as claimed in claim 1, wherein the wall that delimits the central opening of the air cap is disposed so as to be at least in part substantially parallel with the external face of the paint nozzle.

15. The nozzle arrangement as claimed in claim 1, wherein the wall that delimits the central opening of the air cap in a region that faces away from the spraying direction has a spacing from the external face of the paint nozzle that is larger than in a region that faces the spraying direction.

16. The nozzle arrangement as claimed in claim 1, wherein the wall that delimits the central opening of the air cap in a region that faces away from the spraying direction (5) has a spacing from the external face of the paint nozzle that is smaller than in a region that faces the spraying direction.

17. The nozzle arrangement as claimed in claim 1, wherein the wall that delimits the central opening of the air cap is designed so as to be convex at least in regions.

18. The nozzle arrangement as claimed in claim 1, wherein the wall that delimits the central opening of the air cap is designed so as to be concave at least in regions.

19. A nozzle arrangement for a spray gun, in particular a paint spray gun, having at least one paint nozzle and one air cap, wherein the paint nozzle has at least one outlet opening for the material to be sprayed, wherein the air cap has at least one central opening which is delimited by at least one wall, wherein the at least one wall conjointly with at least part of the paint nozzle forms a gap, wherein the paint nozzle at the front end thereof has a substantially hollow-cylindrical plug, and wherein the air cap has an internal face which is adjacent to the wall that delimits the central opening of the air cap and which is disposed on that side of the wall that faces away from the spraying direction, characterized in that an imaginary straight line which runs parallel with the internal face of the air cap and intersects the paint nozzle longitudinal axis does not intersect the hollow-cylindrical plug.

20. The nozzle arrangement as claimed in claim 1, wherein the paint nozzle has at least one duct for conducting air.

21. The nozzle arrangement as claimed in claim 1, wherein said nozzle arrangement has an air-deflection disk for homogenizing the pressure conditions.

22. The nozzle arrangement as claimed in claim 1, wherein the air cap has at least two horns each having at least one horn air opening.

23. The nozzle arrangement as claimed claim 1, wherein the air cap at least in one region between the central opening and the horns has control ducts for exhausting air.

24. The nozzle arrangement as claimed in claim 23, wherein the control ducts in the assembled state of the paint nozzle and the air cap are at least in regions disposed so as to be substantially parallel with the paint nozzle longitudinal axis.

25. The nozzle arrangement as claimed in claim 23, wherein the exhaust end of at least one control duct in the assembled state of the paint nozzle and the air cap faces the paint nozzle longitudinal axis.

26. The nozzle arrangement as claimed in claim 23, wherein the exhaust end of at least one control duct in the assembled state of the paint nozzle and air cap faces away from the paint nozzle longitudinal axis.

27. A spray gun, in particular a paint spray gun, wherein said spray gun has a nozzle arrangement as claimed in claim 1.

28. The spray gun as claimed in claim 27, wherein said spray gun has a hollow needle.
